(19) United States
(12) Patent Application Publication
(10) Pub. No.: US 2018/0275571 A1
(43) Pub. Date: Sep. 27, 2018

(54) MANUFACTURING METHOD FOR SLIDING MEMBER FOR FIXING DEVICE

(71) Applicant: NTN CORPORATION, Osaka (JP)

(72) Inventors: Kazuo HIROSE, Mie (JP); Hiroshi YANAGAWA, Mie (JP); Yoshihide HIMENO, Mie (JP)

(21) Appl. No.: 15/761,108

(22) PCT Filed: Sep. 15, 2016
(86) PCT No.: PCT/JP2016/077346

§ 371 Date: Mar. 18, 2018

(30) Foreign Application Priority Data
Sep. 17, 2015 (JP) 2015-184390
Sep. 15, 2016 (JP) 2016-180055

(51) Int. Cl. G03G 15/20; B29C 59/02; B05D 3/02; B05D 3/12; C09D 127/18

(52) U.S. Cl. CPC G03G 15/2075; B29C 59/022; B29K 2077/00; B05D 3/12; C09D 127/18; B05D 3/0254

(57) ABSTRACT

Relating to a sliding member for a fixing device having a resin coating film on a sliding surface, to provide a manufacturing method for the peeling member for the fixing device capable of forming a fine recessed groove as a lubricant reservoir on a surface of the resin coating film. The manufacturing method for the sliding member for the fixing device includes a coating film forming step of forming a resin coating film by drying a resin coating material after applying the resin coating material including a matrix resin on at least a sliding surface of the base material of the sliding member slid on the belt member, a coating film baking step of baking and hardening the resin coating film, and a recessed portion forming step of forming a recessed portion, which becomes a lubricant reservoir when the coating film baking step is performed, on the surface of the resin coating film, after the coating film forming step and before the coating film baking step.

### TECHNICAL FIELD

The present invention relates to a manufacturing method for a sliding member for a fixing device, in particular, relates to a manufacturing method for a sliding member used in a belt nip type fixing device for reducing sliding resistance in association with rotation of a belt between the belt and a pressing member.

### BACKGROUND ART

In an electronic photographic device such as a copying machine and a laser printer, an image is formed on a paper by fixing an unfixed toner image formed on the paper by using a fixing device. As the fixing device, a fixing device called a belt nip type fixing device, having a configuration provided with a heating roller and a pressing belt arranged to be contacted with the heating roller or a configuration provided with a heating belt and a pressing roller arranged to be contacted with the heating belt is known. In such fixing devices, the belt is arranged to be pressed at an inner surface toward the roller at another side by a pressing member, and a sliding member is arranged between the belt and the pressing member for reducing sliding resistance in association with rotation of the belt. Further, in order to further reduce friction between an inner peripheral surface of the belt and a sliding surface of the sliding member, lubricating oil or grease as a lubricant is applied and supplied to the inner peripheral surface of the belt.

The sliding members disclosed in Patent Document 1 through Patent Document 4 are known. In Patent Document 1, a configuration in which a lattice like uneven shape is formed by means of emboss processing using a metal mesh on a polytetrafluoroethylene (hereinafter, referred to as PTFE) resin layer or a crosslinked PTFE resin layer of a sliding sheet corresponding to the sliding member described above is disclosed. In Patent Document 2, a configuration in which, in order to reduce sliding friction resistance between a fixing film and a film guide, a plurality of recessed portions or grooves is formed on a sliding surface of each of those members is disclosed. In Patent Document 3, a configuration in which a recessed portion that stores a lubricant is formed on an inner surface of a heating roller is disclosed. In Patent Document 4, a configuration in which a thick portion and a thin portion are repeatedly formed on a surface of a sliding sheet corresponding to the sliding member described above is disclosed.

Further, in order to improve sliding performance, a sliding member having an oil reservoir formed by forming a dimple recessed hole or a groove on a sliding surface of a base material of a pressing member arranged at an inner surface side of a belt and by forming a resin coating film on the surface, is known.

### PRIOR ART DOCUMENTS

### Patent Documents

### Patent Document 1: JP 2005-003969 A

### Patent Document 2: JP 2001-042670 A

### Patent Document 3: JP 2002-025759 A

### Patent Document 4: JP 2009-015227 A

### SUMMARY OF THE INVENTION

### Problems to be Solved by the Invention

In the sliding member having the oil reservoir formed by forming a recessed groove or the dimple recessed hole on a surface of a sliding member slid on a belt and by forming the resin coating film on the surface, a diameter of the dimple recessed hole or a width of the recessed groove to be the oil reservoir becomes large, and therefore a pressed surface pressed by the roller is decreased. Consequently, lubricating failure in which a friction coefficient is increased with the elapse of time is generated due to wear of the resin coating film. In order to suppress the increase of the friction coefficient when the sliding member is continuously used, it is preferable to forma fine and precise oil reservoir (recessed groove or the like) on a surface of the resin coating film.

In a case in which the resin coating film is formed by using a resin coating material after forming a fine recessed groove on the sliding surface of the base material of the pressing member so as to form a fine oil reservoir on the surface of the sliding portion, the resin might not be entered into the fine recessed groove or the fine recessed groove might be filled with the resin. Further, in a case in which the fine recessed groove is formed after the coating film is formed (after baking), transferring of the groove is impossible because the coating film is firm, and therefore the coating film might be broken by applying large force for forming the recessed groove. In this way, it is not easy to obtain the fine recessed groove on the surface of the resin coating film of the completed sliding member.

An object of the present invention is, in order to solve such a problem, relating to a sliding member for a fixing device having a resin coating film on a sliding surface, to provide a manufacturing method for the peeling member for the fixing device capable of forming a fine recessed groove as a lubricant reservoir on a surface of the resin coating film.

### Means for Solving the Problem

A manufacturing method for a sliding member for a fixing device of the present invention is for manufacturing the sliding member arranged between a belt member and a pressing member in the fixing device including a fixing member heated by a heating unit and rotated by a driving unit, the belt member rotated in association with rotation of the fixing member, the pressing member that presses the belt member toward the fixing member, and a nit portion formed between the belt member and the fixing member. The manufacturing method includes a coating film forming step of forming a resin coating film by drying a resin coating material after applying the resin coating material including a matrix resin on at least a sliding surface of the base material of the sliding member slid on the belt member, a coating film baking step of baking and hardening the resin coating film, and a recessed portion forming step of forming a recessed portion, which becomes a lubricant reservoir when the coating film baking step is performed, on the surface of the resin coating film, after the coating film forming step and before the coating film baking step.

The matrix resin may be formed of a polyamideimide (hereinafter, referred to as PAI) resin. Further, the resin coating film may include the matrix resin containing at least powder of fluororesin and powder of graphite, and the resin coating film may contain 25 to 70 parts by weight of the fluororesin and 1 to 20 parts by weight of the graphite against 100 parts by weight of the matrix resin. Further, the fluororesin may be formed of a PTFE resin, and the graphite may contain 97.5% or more of fixed carbon.

The recessed portion formed in the recessed portion forming step may be formed as a geometrical pattern groove or a hydrodynamic groove. Further, the geometrical pattern groove may be formed as a one direction inclined pattern groove or a twill pattern groove.

### Effects of the Invention

The manufacturing method for the sliding member for the fixing device of the present invention includes the coating film forming step of forming the resin coating film by drying the resin coating material after applying the resin coating material including the matrix resin on at least the sliding surface of the base material of the sliding member slid on the belt member, the coating film baking step of baking and hardening the resin coating film, and the recessed portion forming step of forming a recessed portion, which becomes a lubricant reservoir when the coating film baking step is performed, on the surface of the resin coating film, after the coating film forming step and before the coating film baking step. That is, the recessed portion forming step is performed between the coating film forming step and the coating film baking step, and thereby the recessed portion is easily formed by means of transfer or the like in a state in which the resin coating film is flexible right after coating and drying, and then the resin coating film having the lubricant reservoir formed of the recessed portion can be formed by baking and hardening the flexible resin coating film. With this, a fine and precise recessed portion can be formed on the surface of the sliding member, compared to a case in which the recessed portion is formed on the surface of the coating film after forming the coating film (after baking), or a case in which a recess is formed on the surface of the base material before forming the resin coating film.

The sliding member having the fine and precise lubricant reservoir obtained by this manufacturing method can reduce an area directly slid on the belt, and since the lubricant is apt to spread over the sliding surface, an increase of the friction coefficient can be suppressed even if the sliding member is continuously used.

Further, since the matrix resin is formed of the PAI resin, excellent heat resistance, wear resistance, and adhesiveness with the base material can be obtained. Further, the resin coating film includes the matrix resin containing at least the powder of the fluororesin and the powder of the graphite, and the resin coating film contains 25 to 70 parts by weight of the fluororesin and 1 to 20 parts by weight of the graphite against 100 parts by weight of the matrix resin. Consequently, excellent low friction performance and wear resistance of the resin coating film can be obtained.

The recessed portion formed in the groove forming step is formed as the geometrical pattern groove or the hydrodynamic groove, and thereby excellent sliding performance of the sliding surface can be obtained.

### BRIEF DESCRIPTION OF THE DRAWINGS

FIG. 1 illustrates a flow of a manufacturing process of a manufacturing method of the present invention.

FIG. 2 illustrates an overview of a belt nip type fixing device.

FIGS. 3(a) and 3(b) illustrate one example of a sliding member obtained through the manufacturing method of the present invention.

FIG. 4 shows an enlarged photo of a surface of the sliding member produced in an experimental example.

### MODE FOR CARRYING OUT THE INVENTION

A sliding member manufactured by a manufacturing method for a sliding member for a fixing device of the present invention is used in a belt nip type fixing device of an electronic photographic device. Examples of the fixing device include (1) a configuration provided with a heating roller as a fixing member, and a pressing belt arranged to be contacted with the heating roller, and (2) a configuration provided with a heating belt as the fixing member, and a pressing roller arranged to be contacted with the heating belt. In such fixing devices, the belt is arranged to be pressed at an inner surface toward the roller at another side by a pressing member. The sliding member is arranged between the belt and the pressing member. The sliding member may be applied to a belt-belt type fixing device provided with a combination of a heating belt as the fixing member and a pressing belt.

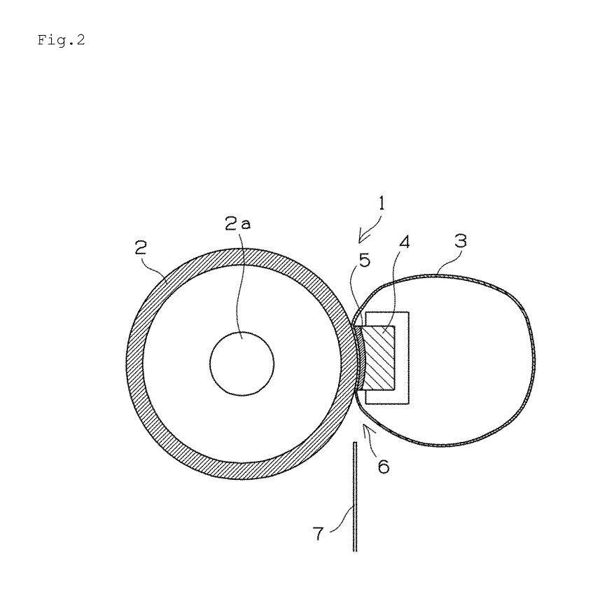

One example of the fixing device is described in detail with reference to FIG. 2. FIG. 2 illustrates an overview of the fixing device having the configuration (1) described above. A fixing device 1 is provided with a heating roller 2 as a fixing member, and a pressing belt 3 as a belt member arranged to be contacted with the heating roller. A heating unit 2a is installed in the heating roller 2. The pressing belt 3 is formed as a hollow rotating member (endless belt). When the heating roller 2 is driven by a driving unit, the pressing belt 3 is driven to follow the heating roller 2. A pressing member 4 is arranged in the pressing belt 3 so as to press the pressing belt 3 toward the heating roller 2. The fixing device 1 is formed to hold a paper 7 on which an unfixed toner image is formed, at a nip portion 6 formed between the heating roller 2 and the pressing belt 3 so as to fix the toner image by heating and pressing the unfixed toner image. In the fixing device 1, a sliding member 5 is arranged between the pressing belt 3 and the pressing member 4. The sliding member 5 is fixed to the pressing member 4. Further, lubricating oil or grease as a lubricant is applied and supplied to an inner peripheral surface of the pressing belt 3 so as to lubricate between the sliding member 5 and the pressing belt 3. As the grease, fluorine grease containing fluorinated oil as a base oil and fluororesin powder as a thickener is mainly used.

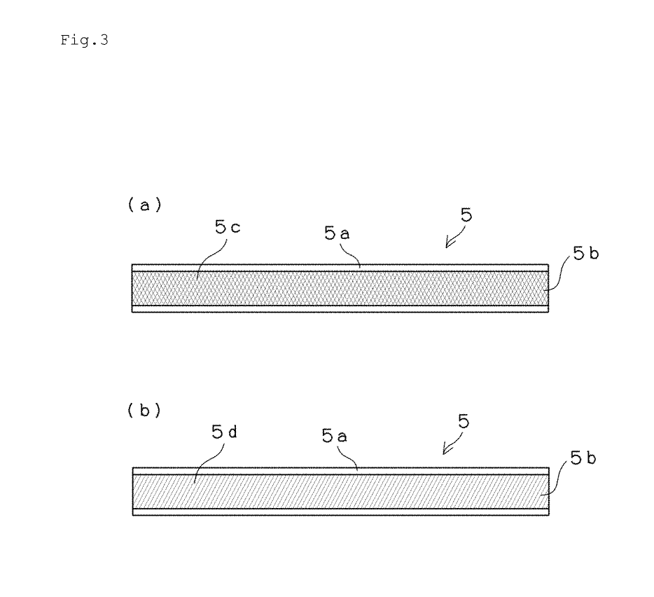

FIGS. 3 (a) and 3 (b) illustrate one example of the sliding member obtained through the manufacturing method of the present invention. FIGS. 3 (a) and 3 (b) are plane views of the sliding member. In the sliding member 5 shown in FIG. 3 (a), a resin coating film 5b is formed on a surface of a base material 5a. A lubricant reservoir 5c having a twill pattern groove is formed on a surface of the resin coating film 5b. Further, in a sliding member 5 shown in FIG. 3 (b), a lubricant reservoir 5d having a one direction inclined pattern groove is formed on a surface of the resin coating film 5b. By forming a fine lubricant reservoir, a decrease of a pressed surface pressed by the roller can be suppressed, and wear of the resin coating film 5b can be prevented.

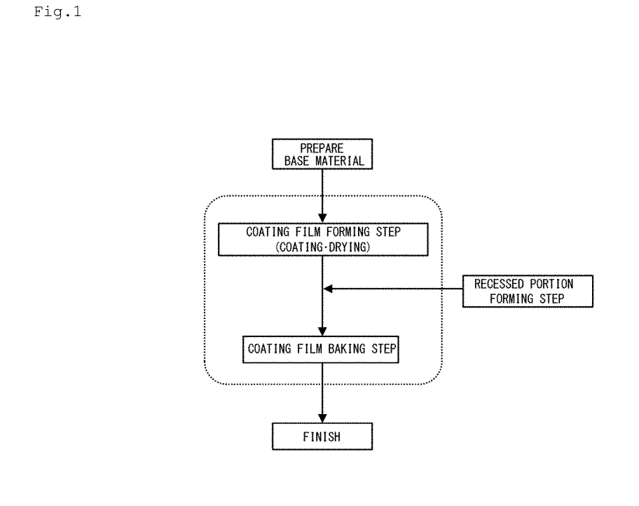

The manufacturing method of the present invention is for manufacturing such a sliding member. The manufacturing method for the sliding member for the fixing device of the present invention is described with reference to FIG. 1. FIG. 1 illustrates a flow of the manufacturing method. In the manufacturing method of the present invention, after preparing the base material of the sliding member, (1) a coating film forming step, (2) a recessed portion forming step, and (3) a coating film baking step are performed in this order. Especially, the coating film forming step and the coating film baking step are normally continuously performed (shown by a dotted line in FIG. 1), while the recessed portion forming step is performed between the coating film forming step and the coating film baking step. Each process is described below.

At first, a base material of the sliding member is prepared. A shape of the base material is determined in accordance with a configuration of the fixing device to which the sliding member is applied or a shape of the pressing member, and for example, a plate like shape, a sheet like shape, or a shape in which the sliding surface is formed in a curved surface or an arc like surface may be adopted. Further, the pressing member may be formed as the base material of the sliding member without forming the pressing member as a separated member from the base material, and the resin coating film may be formed on the sliding surface of the pressing member against the belt.

The base material is required to endure a temperature in baking of the resin coating film, and therefore a base material formed of metal is mainly adopted. For example, by adopting iron, aluminum, aluminum alloy, copper, or copper alloy as the material of the base material, required load resistance can be obtained. Examples of iron include stainless steel (SUS304, SUS316, or the like), soft steel (SPCC, SPCE, or the like), and carbon steel for general structure (SS400). Further, plating of zinc, nickel or copper may be applied to the iron described above. Examples of aluminum include A1100 and A1050, examples of aluminum alloy include A2017 and A5052 (including a material subjected to alumite treatment), example of copper includes C1100, and examples of copper alloy include C2700 and C2801.

Further, in order to improve the adhesiveness with the resin coating film, a surface on which the resin coating film is formed of the base material formed of the metal is roughened to form an uneven shape by means of shot blast, tumbler, machining or the like, or alternatively a fine uneven shape may be formed by applying a chemical surface treatment.

(1) Coating Film Forming Step

In the present step, the resin coating film is formed by drying the resin coating material after applying the resin coating material including the matrix resin. The resin coating material is obtained by dispersing or dissolving the matrix resin and other compounding agent, which become a solid content, into a solvent.

As the matrix resin, resin having excellent adhesiveness and excellent heat resistance that is not deteriorated by heat when the sliding member is used may be adopted. Specifically, examples of the matrix resin include a PAI resin, a polyphenylene sulfide resin, a polyether ether ketone resin, a polyimide resin, a polyamide resin, an epoxy resin, and a phenol resin. Of these resins, the PAI resin is preferable because excellent heat resistance, wear resistance, and adhesiveness with the base material are obtained.

As the solvents into which the matrix resin or the like is dispersed, for example, ketones such as acetone, methyl ethyl ketone; esters such as methyl acetate and ethyl acetate; aromatic hydrocarbons such as toluene and xylene; organic halogen compounds such as methyl chloroform, trichloroethylene, and trichlorotrifluoroethane; and non-proton extreme solvents such as N-methyl-2-pyrrolidone (NMP), methylisopyrrolidone (MIP), dimethylformamide (DMF), dimethylacetamide (DMAC) may be used. These solvents can be used independently or as mixtures thereof. A kind of the solvent and viscosity thereof may be adjusted in accordance with a coating method of the resin coating material.

A coating method of coating the surface of the base material with the resin coating material is not especially limited, and for example, a spray coating method may be adopted. The resin coating material may be applied on at least the sliding surface of the base material slid on the belt member.

The drying in this step is performed to such an extent that the recessed portion can be formed in the next step of the recessed portion forming step. In a state in which much solvent is remained in the resin coating material, the resin coating film has liquidity, and even if a recessed portion is formed by means of transfer, the coating material flows and therefore the recessed portion is collapsed. Thus, the resin coating material is dried to such an extent that a groove is not collapsed when forming the recessed portion even if a part of the solvent is remained in the resin coating film. Specifically, it means a state in which a ratio of the solid content in the resin coating film is 70 wt. % or more. The ratio of the solid content in the resin coating film can be managed easily by measuring each weight of a product before coating, right after coating, and after drying. Further, by setting a film thickness of the resin coating film after drying to 12 μm to 36 μm, the resin coating film after baking is formed in a required film thickness. Further, in a case in which a finishing process is performed after baking, the film thickness of the resin coating film after drying may be set to 20 μm to 50 μm.

(2) Recessed Portion Forming Step

In the present step, a recessed portion to be the lubricant reservoir after the coating film forming step, is formed. The resin coating film obtained in the coating film forming step, which is the former step, is low in strength and in a flexible state, compared to the resin coating film after baking. The present step is performed right after the coating film forming step to use the state of the resin coating film. The recessed portion formed in the present step eventually becomes the lubricant reservoir on the surface of the resin coating film of the sliding member through the next step of the baking step. A shape of the recessed portion is substantially the same as a shape of the completed lubricant reservoir.

The shape of the recessed portion is not especially limited, and therefore any shape such as a dimple recessed hole and a recessed groove may be adopted. Further, a depth of the recessed portion may be formed such that the recessed portion reaches the surface of the base material. The recessed groove may be formed as, for example, a geometrical pattern groove such as a one direction inclined pattern groove and a twill pattern groove or a hydrodynamic groove such as a herringbone groove and a spiral groove. It is preferable that the recessed groove is formed to be orthogonal to a sliding direction.

As shown in FIGS. 3(a) and 3(b), the one direction inclined pattern groove (FIG. 3 (b)) and the twill pattern groove (FIG. 3(a)) are formed by linear grooves inclined in one direction or two directions (twill pattern) against a paper passing direction and aligned at the same intervals. In the present step, such grooves can be formed by pressing a knurling piece against the surface of the resin coating film while rotating. In the present step, it is preferable to form a fine recessed portion that cannot be formed in a case in which a recessed portion is formed on a surface of the coating film after forming the coating film (after baking) and in a case in which a recessed portion is formed on the surface of the base material before forming the resin coating film. Thus, the one direction inclined pattern groove or the twill pattern groove is formed by pattern grooves having a groove width of 30 μm to 500 μm (preferably 30 μm to 100 μm) and a pitch of 0.4 mm to 1.5 mm (preferably 0.5 mm to 1.0 mm).

The shape of the hydrodynamic groove such as a herringbone groove and a spiral groove can be formed by means of transfer by pressing a transferring member corresponding to each shape. In order to fine the groove for a similar reason to the twill pattern groove or the like, it is preferable that the groove width is set to approximately 100 μm.

Further, in a case in which the recessed portion is formed as the dimple recessed hole, in order to fine the recessed portion for a similar reason to the twill pattern groove or the like, it is preferable to form twenty five or more of recesses having φ 1.5 mm or less per 1 cm², more preferably fifty or more of the recesses having φ 1.0 mm or less per 1 cm².

(3) Coating Film Baking Step

In the present step, the resin coating film on which the recessed portion is formed in the recessed portion forming step, which is the former step, is baked to harden the resin coating film. The baking is performed at a baking temperature in accordance with the matrix resin. The resin coating film is baked and hardened through the baking step and then firm resin coating film with the lubricant reservoir having a predetermined shape is obtained.

The thickness of the resin coating film in the sliding member is 10 μm to 30 μm. The finishing process may be performed by cutting the surface of the resin coating film after the baking so as not to collapse the lubricant reservoir. The sliding member having the lubricant reservoir obtained by this manufacturing method can reduce an area directly slid on a belt due to a fineness of the lubricant reservoir. Further, since the lubricant reservoir is precisely formed such that the groove is not collapsed, the lubricant is apt to spread over the sliding surface, and low friction performance can be obtained over the sliding surface and an increase of the friction coefficient with the elapse of time can be suppressed.

In order to further improve friction and wear performance of the resin coating film of the sliding member, it is preferable to compound at least fluororesin powder and carbon powder as a compounding agent into the matrix resin.

As the fluororesin, resin having heat resistance and capable of imparting low friction performance and unadhesiveness to the resin coating film may be adopted. Examples of the fluororesin, include a PTFE resin, a tetrafluoroethylene-perfluoroalkyl vinyl ether (PFA) copolymer resin, a tetrafluoroethylene-hexafluoropropylene (FEP) copolymer resin, and a tetrafluoroethylene-ethylene (ETFE) copolymer resin. Of these fluororesins, it is preferable to adopt powder of the PTFE resin.

In a case in which the powder of the PTFE resin is adopted, the average particle diameter (a value measured by laser analysis method) of the powder is not especially limited, however it is preferable that the average particle diameter is set to 30 μm or less to keep the surface smoothness of the resin coating film.

The powder of the PTFE resin obtained by baking the PTFE resin at a temperature of its melting point or more may be adopted. The powder obtained by irradiating the baked powder with y rays or electron rays may be also adopted. The baked powder of the PTFE resin has excellent uniform dispersion performance in the resin coating material and imparts excellent wear resistance to the formed resin coating film, compared to unbaked PTFE resin (molding powder, fine powder).

It is preferable that the resin coating film contains 25 to 70 parts by weight of the fluororesin such as the PTFE resin against 100 parts by weight of the matrix resin. In a case in which the compounding amount of the fluororesin is less than 25 parts by weight, the low friction performance is deteriorated, and thereby wear due to heat might be accelerated. On the other hand, in a case in which the compounding amount of the fluororesin exceeds 70 parts by weight, excellent low friction performance can be obtained, while strength of the coating film and the wear resistance might be deteriorated.

It is well known that the graphite has excellent characteristics as a solid lubricant. The graphite is classified into natural graphite and artificial graphite, however both of them can be adopted. Examples of a shape of the graphite include a flaky shape, a granular shape, and a spherical shape, and all of them can be adopted.

It is preferable to adopt the graphite having 97.5% or more of fixed carbon, and more favorable to adopt artificial graphite having 98.5% or more of the fixed carbon. Such graphite is highly compatible with lubricating oil, and even if the lubricating oil is not adhered to a surface of a part of the graphite, lubricating performance is ensured due to the lubricating oil slightly impregnated in the graphite.

It is preferable that the resin coating film contains 1 to 20 parts by weight of the graphite against 100 parts by weight of the matrix resin. In a case in which the compounding amount of the graphite is less than 1 part by weight, the effect of adding the graphite to the matrix resin cannot be obtained sufficiently. On the other hand, in a case in which the compounding amount of the graphite exceeds 20 parts by weight, adhesiveness of the resin coating film is deteriorated, and therefore the resin coating film might be peeled.

In addition to the matrix resin, the fluororesin, and the graphite, the resin coating film may contain other additives unless necessary characteristics of the sliding member of the present invention are extremely deteriorated. In a case in which the total amount of the additives such as the fluororesin and the graphite against the matrix resin is less than 15 parts by weight, the resin coating film is ununiform in its thickness, and therefore it is difficult to obtain a required dimensional accuracy.

Further, it is preferable that tensile shear adhesive strength of the resin coating film is set to 25 MPa or more. In such a case, adhesion strength between the base material of the sliding member and the resin coating film becomes high, and therefore the sliding member can be used stably even if the contact surface pressure with the belt becomes high. In a case in which the resin coating film contains the PAI resin as the matrix resin, and the powder of the fluororesin and the powder of the graphite in the preferable compounding range described above, the tensile shear adhesive strength becomes 25 MPa or more.

### Experimental Example

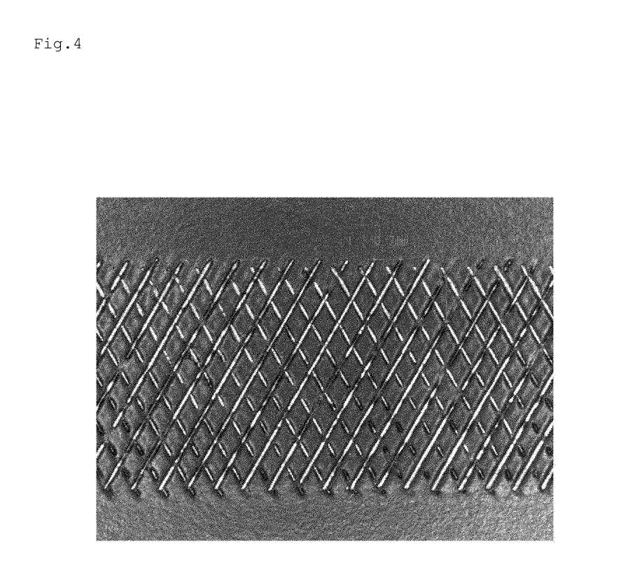

A plate of SUS304 polished after cutting is used as the base material, and then the base material is roughened to increase surface roughness by means of shot blast. The resin coating material described below is applied to the base material and dried at a temperature of 90° C. for 20 minutes. A film thickness of the resin coating film at this time was 30 μm. After that, the twill pattern groove is formed by pressing a knurling piece while rotating against the surface of the resin coating film with pressure to such an extent that the base material is slightly exposed or not. Such a base material is baked at a temperature of 240° C. for one hour to obtain the resin coating film. A film thickness of the resin coating film after baking was 25 μm. FIG. 4 shows a photo of a surface of the resin coating film of the obtained sliding member. In this photo, the twill pattern portion as the lubricant reservoir has a pitch of 0.7 mm, and a groove width of 100 μm.

A solid content of the resin coating material is described below. As the resin coating material, PAI resin varnish in which the PAI resin is dispersed in N-methylpyrrolidone is used. After PTFE resin and graphite powder are added to the PAI resin varnish, the solution is diluted. Each of 45 parts by weight of the PTFE resin against 100 parts by weight of the PAI resin and 10 parts by weight of the graphite powder against 100 parts by weight of the PAI resin is compounded.

(a) PTFE: PTFE resin (average particle diameter: 10 μm, calcined material)

(b) PAI: article having a glass transition temperature of 245° C.

(c) Graphite powder: artificial graphite (average particle diameter: 10 μm)

As shown in FIG. 4, by using the manufacturing method of the present invention, the fine and precise lubricant reservoir can be formed on the surface of the resin coating film of the sliding member.

### INDUSTRIAL APPLICABILITY

The manufacturing method for the sliding member of the fixing device of the present invention can form a fine recessed groove or the like to be the lubricant reservoir on the surface of the resin coating film in the sliding member for the fixing device having the resin coating film on the sliding surface, and therefore the manufacturing method is suitable for the sliding member used in the belt nip type fixing device.

### REFERENCE SIGNS LIST

1: fixing device
2: heating roller
3: pressing belt
4: pressing member
5: sliding member
6: nip portion
7: paper

1. A manufacturing method for a sliding member for a fixing device, the sliding member being arranged between a belt member and a pressing member in the fixing device including a fixing member heated by a heating unit and rotated by a driving unit, the belt member rotated in association with rotation of the fixing member, the pressing member that presses the belt member toward the fixing member, and a nit portion formed between the belt member and the fixing member, the manufacturing method comprising:
a coating film forming step of forming a resin coating film by drying a resin coating material after applying the resin coating material including a matrix resin on at least a sliding surface of the base material of the sliding member slid on the belt member;
a coating film baking step of baking and hardening the resin coating film; and
a recessed portion forming step of forming a recessed portion, which becomes a lubricant reservoir when the coating film baking step is performed, on the surface of the resin coating film, after the coating film forming step and before the coating film baking step.

2. The manufacturing method for the sliding member for the fixing device according to claim 1, wherein the matrix resin is formed of a polyamideimide resin.

3. The manufacturing method for the sliding member for the fixing device according to claim 1, wherein:
the resin coating film comprises the matrix resin containing at least powder of fluororesin and powder of graphite; and
the resin coating film contains 25 to 70 parts by weight of the fluororesin and 1 to 20 parts by weight of the graphite against 100 parts by weight of the matrix resin.

4. The manufacturing method for the sliding member for the fixing device according to claim 3, wherein:
the fluororesin is formed of a polytetrafluoroethylene resin; and
the graphite contains 97.5% or more of fixed carbon.

5. The manufacturing method for the sliding member for the fixing device according to claim 1, wherein the recessed portion formed in the recessed portion forming step is formed as a geometrical pattern groove or a hydrodynamic groove.

6. The manufacturing method for the sliding member for the fixing device according to claim 5, wherein:
the recessed portion formed in the recessed portion forming step is formed as the geometrical pattern groove; and
the geometrical pattern groove is formed as a one direction inclined pattern groove or a twill pattern groove.
